(19) United States
(12) Patent Application Publication
(10) Pub. No.: US 2024/0000266 A1
(43) Pub. Date: Jan. 4, 2024

(54) Electronic Gas Grill Temperature Control Apparatus and Method

(71) Applicant: Nexgrill Industries, Inc., Chinio, CA (US)

(72) Inventors: Joe Burch, La Grange, GA (US); Colin Chen Joehy, Shenzhen City (CN)

(73) Assignee: Nexgrill Industries, Inc., Chinio, CA (US)

(21) Appl. No.: 18/217,109

(22) Filed: Jun. 30, 2023

Related U.S. Application Data
(60) Provisional application No. 63/357,836, filed on Jul. 1, 2022.

(51) Int. Cl. A47J 37/07; F23N 1/00

(52) U.S. Cl. CPC A47J 37/0786; A47J 37/0713; F23N 1/007; F23N 2235/16; F23N 2235/24; F23N 2239/04

(57) ABSTRACT

System involved with but not limited to an apparatus including a temperature control system capable of quickly heating a grill to a precise and consistent temperature using a plurality of gas burners and associated electronic control method thereof. In an exemplary non-limiting application, the system uses a solenoid valve to control flow to a plurality of motorized modulating valves, which in turn modulate gas flow to a gas burner. The apparatus and method of use thereof is capable of producing precise cooking temperatures by adjusting the volume of gas flow to the burners via motorized modulating valves, allowing for more precise and consistent cooking temperatures than systems utilizing valves featuring only a limited number of positions, such as open or closed, or high flow or low flow.

### CROSS-REFERENCE TO RELATED APPLICATION

This application claims the benefit of, and priority from, U.S. Provisional Application No. 63/357,836, filed Jul. 1, 2022 the disclosures of which are hereby incorporated by reference in their entirety as if fully set forth herein.

### TECHNICAL FIELD

Embodiments of the present disclosure relate generally to cooking apparatuses, including, but not limited to, barbeque grills, smokers, and ovens. More specifically, aspects of the present disclosure relate to temperature control methods and systems utilized in conjunction with a gas burner capable of producing a flame or flames of varying intensities. Further aspects of the present disclosure include methods of manual and electronic control to achieve a desired cooking temperature, which may be managed through the use of components capable of measuring the temperature of the cooking surface and/or cooking area of the barbecue grill, smoker, and/or oven.

### BACKGROUND

Outdoor cooking is a popular tradition in much of the world. Outdoor cooking may be achieved via various modes, but the most common systems utilized for cooking outdoors are barbeque grills, devices which cook food by providing heat in an area below a grill or grate. The heat is often provided via two methods: (1) a gas fuel, such as propane or natural gas, or (2) a solid fuel such as wood and/or charcoal. Other modes include electrical heating elements. These two types of barbeque grills are generally referred to as “gas grills” or “charcoal grills.” Grills may also be used to smoke food items, which is a cooking process that uses a low, steady heat source to apply heat and smoke for a longer period of time to cook a food item. Dedicated smoking devices, or smokers, are advantageous for cooking larger cuts of meat and impart a smoky flavor into meats and vegetables cooked therein, as well as serving an anti-microbial purpose.

A barbecue grill is a cooking device that is used in both residential and commercial applications for a range of cooking methods. A grill is commonly a grated metal structure made of cast or wrought iron, aluminum, or steel. A smoker often uses a door or lid to prevent the escape of heat provided by a heat source, doing so allows the device to maintain heat at a consistent temperature. Such cooking devices are often heated by open flames, applied directly or indirectly. A number of methods of temperature control have been developed, including managing the amount of air and fuel available to control the rate of combustion of the fuel, which in turn allows the user to exert control over the temperature of the cooking surface. The present disclosure is capable of controlling temperature through the modulation of a fluid fuel and monitoring the temperature of the cooking surface.

Many electronically-controlled gas grills operate at a constant fluid fuel pressure and route fuel through a number of solenoid valves with a finite number of settings that control the amount of fuel available to be ignited at the burner. The more fuel available, the higher the resulting temperature. These gas grills route fuel through a number of solenoid valves and adjust the flow of fuel by opening or closing individual valves between the fuel source and the burners. For example, one solenoid may communicate fuel to two more valves, which in turn communicates fuel to a burner; if all three are open, the burner receives 100% of the fuel available to the first solenoid valve; if one of the two valves nearest the burner is closed while the other two are open, the burner receives 50% of the fuel available at the burner; if any two or all valves are closed, the burner receives no fuel. By utilizing greater numbers of valves, fuel lines, and burners of different sizes, a greater, but still finite, number of fuel flow settings may be achieved by setting various solenoid valves to open or closed. Generally, the more valves that are open, the more fuel available to burn. However, utilizing valves with only a finite number of settings limits the number of fuel burn rates that may be achieved by the system. As a result, a control apparatus may try to achieve an average set temperature by opening and closing one or more valves, resulting in inconsistent application of heat. For example, if a user sets a desired temperature at 225 degrees Fahrenheit but the gas flow system may only open and close valves to supply fuel to the burners in a manner allowing minimum variations of 10 degrees Fahrenheit, the control system may alternate opening and closing valves such that the temperature fluctuates between 220 degrees Fahrenheit and 230 degrees Fahrenheit. Other systems may operate like a thermostat, wherein a valve is shut off after the temperature reaches a certain set point, then opened again once the measured temperature falls below that set point. In both circumstances, the temperature fluctuates above and below the desired temperature with varying degrees of precision.

The present disclosure improves over the prior art by eliminating exclusive reliance upon electronically-controlled solenoid valves with a limited number of settings. In an exemplary non-limiting application, the present disclosure may use a motorized modulating valve in fluid communication with a burner to deliver fuel at a continuously variable rate, which allows for very small degrees of adjustment. This application may allow for a temperature to be achieved and maintained on a consistent basis without variation above and below the desired temperature, even when ambient conditions change. This application also represents an improvement over prior art in its relative simplicity of design in that the application may obtain any number of temperatures through the use of fewer burners and valves. Each provided exemplary motorized modulating valve in fluid communication with a single burner is capable of providing consistent temperatures that may be adjusted with fine precision of less than 1 degree Fahrenheit. A plurality of exemplary motorized modulating valves in fluid communication with one or more burners may provide multiple heating zones capable of producing temperatures that may be adjusted with fine precision.

### SUMMARY

It is an object, feature, and/or advantage of the present disclosure to provide an improved fuel control apparatus and methods of use thereof that overcome deficiencies in the prior art. In accordance with one exemplary aspect, a cooking system is provided having a heat source containment structure housing hingedly attached to a lid with at least one fuel control assembly disposed therein. An exemplary fuel control assembly may include a valve assembly in fluid communication with at least one motorized modulating valve and a source of fluid fuel supply. In an exemplary embodiment, this valve is the first valve in fluid communication with the fluid fuel supply, and may be used to provide or stop the flow of fuel to the temperature control apparatus. Such a valve could be electronically controlled, such as a solenoid valve assembly, or manually controlled, and may be adjustable or be limited to an on/off setting. Each exemplary motorized modulating valve is provided in fluid communication with at least one burner capable of igniting and sustaining combustion of a fluid fuel source. Each exemplary solenoid and motorized modulating valve may be provided in electronic communication with an electronic control module capable of receiving user inputs, receiving information from electronic system components, and transmitting commands to system components. An exemplary electronic control module may be capable of receiving user commands through digital or analog controls disposed on the grill itself, or through a remote device such as a smartphone. A solenoid may be provided to control the supply of fuel to one or more motorized modulating valves. One or more motorized modulating valves may be provided to provide continuously variable flow of fuel to one or more burners in fluid communication with said motorized modulating valve. One or more ignitor modules capable of igniting a fluid fuel may be provided in proximity with one or more associated burners and in electronic communication with an electronic control module. One or more devices capable of detecting and transmitting temperature information, such as a thermocouple, may be provided in electronic communication with an electronic control module and disposed in proximity to one or more burners provided in fluid communication with an individual motorized modulating valve. A device capable of detecting and transmitting ambient temperature information, such as a resistance temperature detector, may be provided in electronic communication with an electronic control module and disposed in the containment structure housing in a location, such as the interior of the grill lid where it is capable of detecting the air temperature of the cooking space.

### BRIEF DESCRIPTION OF THE DRAWINGS

The accompanying drawings, which are incorporated in, and which constitute a part of this specification, illustrate exemplary constructions and procedures in accordance with the present disclosure and, together with the general description of the disclosure given above and the detailed description set forth below, serve to explain the principles of the disclosure wherein:

FIG. 1 is a component map of an exemplary configuration of the disclosure;

FIG. 2 is a side view of an exemplary configuration of a solenoid valve provided in fluid communication with two motorized modulating valves;

FIG. 3 is a perspective view of the exemplary configuration of a solenoid valve provided in fluid communication with two motorized modulating valves of FIG. 2;

FIG. 4 is an internal view of an individual exemplary motorized modulating valve of FIGS. 2 and 3;

FIG. 5 is an exploded view of an individual exemplary motorized modulating valve of FIGS. 2, 3, and 4.

FIG. 6 is an internal view of an exemplary solenoid valve of FIGS. 2 and 3;

FIG. 7 is a lateral view of the exemplary solenoid valve of FIG. 6:

FIG. 8 illustrates a flow chart of a control method for starting up an electronically-controlled cooking apparatus;

FIG. 9 illustrates a flow chart of a control method for igniting the burner of an electronically-controlled cooking apparatus;

FIG. 10 illustrates a flow chart of a control method for utilizing the burner of an electronically-controlled cooking apparatus to clean the burners and grate of a cooking apparatus;

FIG. 11 illustrates a flow chart of a control method for automatically heating the cooking area of an electronically-controlled cooking apparatus; and

FIG. 12 illustrates a flow chart of a control method for achieving a desired temperature on an electronically-controlled cooking apparatus.

While constructions consistent with the present disclosure have been illustrated and generally described above and will hereinafter be described in connection with certain potentially preferred embodiments and practices, it is to be understood that in no event is the disclosure limited to such illustrated and described embodiments and practices. On the contrary, it is intended that the present disclosure shall extend to all alternatives and modifications as may embrace the general principles of this disclosure within the full and true spirit and scope thereof. Also, it is to be understood that the phraseology and terminology used herein are for purposes of description only and should not be regarded as limiting. The use herein of terms such as “including” and “comprising” and variations thereof is meant to encompass the items listed thereafter and equivalents thereof as well as additional items and equivalents thereof.

### DETAILED DESCRIPTION

It is an object, feature, and/or advantage of the present disclosure to provide an improved fuel control apparatus and methods of use thereof that overcome deficiencies in the prior art. The disclosed electronic gas control apparatus provides advantages over prior art gas control apparatus used in cooking apparatuses.

A discussion of the prior art is helpful to illustrate how the present disclosure overcomes deficiencies in the prior art. Electronically-controlled fuel delivery systems for use in cooking apparatuses disclosed in prior art deliver fuel to a burner through a number of valves with a finite number of settings that control the amount of fuel that may pass through each valve. Solenoid valves often used in these applications have a limited number of settings, such as open or closed, or high flow or low flow, configured to open or close in response to an electrical current. The amount of fuel delivered to the burners may be controlled by adjusting certain valves from open to closed, or from high to low, or vice versa. The more fuel available, the higher the resulting temperature. For example, a seven-valve configuration may have a first valve (1) in fluid communication with two high/low valves (2 and 3). High/low valve 2 is in turn in fluid communication with on/off valves 4 and 5, and high/low valve 3 is provided in fluid communication with on/offvalves 6 and 7. On/offvalves 4, 5, 6, and 7 are provided in fluid communication with burners of varying sizes. For purposes of illustration, the burner in communication with on/off valve 4 may burn enough fuel under given conditions to generate heat to maintain a temperature of 200 degrees Fahrenheit. The burner in fluid communication with valve 5 may generate enough heat add 100 degrees Fahrenheit to the cooking surface. The burner in fluid communication with valve 6 may generate enough heat add 50 degrees Fahrenheit to the cooking surface. The burner in fluid communication with valve 5 may generate enough heat add 25 degrees Fahrenheit to the cooking surface. High/low valves 2 and 3 may deliver fuel at two rates: 100% flow (High) and 50% flow (Low). If a user selects 210 degrees Fahrenheit as the set temperature, the control system, based on its control logic, would then select the following settings after initially heating to a set temperature: Valve 1: On; Valve 2: High; Valve 3: Low; Valve 4: On; Valve 5: Off; Valve 6: Off; Valve 7: On. Valve 1 provides fuel to the system, Valve 2 provides 100/fuel flow to Valve 4, which burns the maximum available amount of fuel to add 200 degrees Fahrenheit to the cooking surface. Valves 5 and 6 are closed and therefore provide no fuel to their respective burners. Valve 7, which is receiving 50% fuel flow through Valve 3, adds 50% of its heat-adding capacity of 25 degrees Fahrenheit, or 12.5 degrees Fahrenheit. The system in this configuration therefore burns enough fuel under given conditions to consistently maintain a temperature of 212.5 degrees Fahrenheit. The prior art control system may employ thermostatic control and close Valve 7 when the system detects a temperature above 210 degrees and re-open Valve 7 when the temperature falls back below 210 degrees. Such a cooking apparatus is incapable of generating and maintaining a consistent temperature if the selected set temperature is a value that is not divisible by 12.5. When the desired temperature may not be generated by such a system, the control system modulates fuel delivery to the burners so that the temperature fluctuates above and below the desired temperature with varying degrees of precision. The instant disclosure overcomes this deficiency by providing a system capable of electronic temperature detection and control in conjunction with one or more motorized modulating valves that may supply a continuously variable rate of fuel delivery to be burned. Continuously variable fuel delivery allows for fine adjustment of fuel delivery rate to the burners, which allows for a precise temperature to be achieved and consistently maintained. The present disclosure also improves upon the prior art by being more fuel efficient because the fuel is not burned to generate a temperature greater than the desired temperature.

In accordance with one exemplary aspect, a cooking system is provided having a heat source containment structure housing hingedly attached to a lid with at least one fuel control assembly disposed therein. An exemplary fuel control assembly may be provided in fluid communication with one or more fuel sources and one or more burners capable of igniting and maintaining combustion of a fluid fuel, such as kerosene, natural gas, or propane. One or more burners may heat a grated cooking surface or cooking volume to a desired temperature in order to apply cooking heat to a food article. With the lid closed, the ambient air above the cooking surface may be heated to higher temperatures than those available with the lid open to provide additional cooking heat via an oven effect. Heat-resistant temperature-measuring devices, such as a thermocouple or a resistance temperature detector, may be disposed near the cooking surface, the interior of the lid, or within the firebox to detect the temperatures of the cooking surface and the air temperature of the cooking chamber when the lid is placed in a closed position. Exemplary temperature detecting devices may be provided in electronic communication with an electronic control module capable of receiving temperature information.

An exemplary fuel control assembly may include a solenoid in fluid communication with at least one motorized modulating valve and one or more sources of fluid fuel supply. In this exemplary embodiment, the solenoid valve is the first valve through which fluid fuel passes from one or more fuel sources. An exemplary solenoid valve functions as a fail-safe and may either allow fuel to be provided to the fuel control system or stop the flow of fuel to the system. An exemplary solenoid valve is placed in electronic communication with an electronic control module capable of providing electric power to open and close the solenoid valve. One or more exemplary motorized modulating valve is provided in fluid communication with the fail safe solenoid valve and with one or more burners.

Each exemplary motorized modulating valve may be provided in electronic communication with an electronic control module capable of powering and transmitting electronic commands to each motorized modulating valve. An exemplary motorized modulating valve can be fully open, fully closed, or can be disposed at a position in between open and closed, allowing for partial fuel flow at any number of rates depending on the position of the valve. An exemplary motorized modulating valve controls the rate of fuel flow from the solenoid to one or more burners provided in fluid communication with each motorized modulating valve and may provide any rate of flow between fully open and fully closed. An exemplary electronic control module may communicate commands to a motorized modulating valve to actuate the position of the valve, thereby controlling the rate of flow of fluid fuel from one or more fuel sources to one or more burners.

In one embodiment of the present disclosure, a motorized modulating valve adjusts the rate of flow of a fluid fuel through the valve by rotating a plug with a tapered slot disposed adjacently to a fixed orifice. An exemplary valve may be cylindrical in shape with one end terminating in a frustoconical protrusion defining a valve plug. The frustoconical protrusion may have a partial band cut out of the exterior surface, defining a channel around a portion of the circumference of the protrusion. The channel may widen circumferentially from its terminus. In an open position, the channel formed in the outer surface of the valve plug, together with the fixed orifice, defines an opening through which a fluid fuel may pass from the solenoid to one or more burners, each in fluid communication with the motorized modulating valve. As the valve plug is rotated, the position of the channel and the channel's corresponding width provides a lesser or greater volume through which a fluid fuel may pass through the valve assembly. As the valve plug is rotated from a fully open position, the volume of the opening defined by the channel in the frustoconical valve plug and the fixed orifice decreases, reducing the volume of fluid fuel that may pass through the opening under static pressure. When the frustoconical portion of the valve plug is rotated such that no portion of the channel is in alignment with either the valve inlet or outlet, no fluid fuel may pass through, thus defining a closed position of the valve.

Embodiments described herein may also include a number of different species of motorized modulating valves, such as bonnet valves, butterfly valves, ball valves, globe valves, control valves, diaphragm valves, gate valves, or any other kind of valve known in the art to be capable of regulating flow of a fluid in a continuously variable manner. In this regard, it is to be understood that continuous variables are variables that can take on any value within a range and may be constant at a given value for a time. Various types of valves may be provided with a mechanical linkage to an electronically controlled electric motor, enabling precise adjustment of the valve's position to encompass a full range from fully open to fully closed, as well as any intermediate positions.

Each exemplary motorized modulating valve is provided in fluid communication with at least one burner assembly capable of igniting and sustaining combustion of a fluid fuel source. An exemplary, non-limiting burner assembly may include an ignitor module provided in electronic communication with an electronic control module. In another embodiment, an exemplary ignitor module in electronic communication with an electronic control module may be provided separately from a burner assembly and disposed in a location near the burner such that it is capable of igniting fluid fuel at the burner. An exemplary multipoint electronic control unit may be provided in electronic communication with one or more ignitor modules capable of igniting a fluid fuel at one or more respective burners, such as using a crossover channel capable of communicating ignitable fluid fuel from one burner with no ignitor module to a burner assembly including an ignitor module. In such a configuration, a flame lit at one burner may be used to ignite the fuel in the crossover channel, communicating the flame back to the burner with no ignitor module An exemplary multipoint electronic control unit may provide power and an ignition signal to one or more ignitor modules.

An exemplary electronic control module may be provided to communicate electronic signals to and from components of the disclosed system, including valves, ignitor modules, and temperature detecting devices. The electronic control module may also provide electric power to components of the disclosed system. An exemplary electronic control module may also be capable of receiving and transmitting user commands to components of the disclosed system, including, but not limited to commands to (1) actuate the valve to an open or closed position, thereby controlling fuel supply to the system; (2) actuate the position of the valves in one or more motorized modulating valves thereby controlling fuel flow rate to one or more burners in fluid communication with each motorized modulating valve; and (3) activate one or more ignitor modules capable of igniting a fluid fuel at one or more provided burners. The electronic control module may also be capable of receiving information from components of the disclosed system, including but not limited to detected temperatures, the positions of the solenoid and motorized modulating valves, and flow rates of fluid fuel. A sensor capable of detecting whether the lid is open or closed may also be provided in electronic communication with the electronic control module in order to provide the system with information about the amount of ambient air available for combustion. Such information may be used by the multipoint control system to lower the amount of fuel delivered to one or more burners in the system to avoid or mediate flare-ups when the lid of an exemplary grill or smoker is opened.

An exemplary electronic control module may be capable of receiving user commands through digital or analog controls disposed on the grill itself, or through a remote device such as a smartphone. The electronic control module may also be capable of receiving information from system components and transmitting that information back to the user through a provided control panel disposed on the exterior of the cooking apparatus, or to a remote device in communication with the multipoint control system, such as a smartphone. Such information may include, but is not limited to, the temperature of the cooking surface associated with one or more burners in fluid communication with an exemplary motorized modulating valve, the temperature of the air inside the cooking space of the grill with the lid closed, whether a provided burner is combusting fluid fuel, the positions of the motorized modulating valves in the system, whether or not the solenoid valve is open or closed, temperature of the cooking volume, and individual temperatures of multiple cooking zones. A user may input commands, such as a startup command, shutoff command, or desired temperature for burners associated with one or more motorized modulating valves, through a provided control panel or a remote device in communication with an electronic control module.

In an exemplary embodiment, analog knobs may be provided on a control panel that may be used by the user to input a temperature or ignition command to the cooking apparatus and the control panel may display information, such as set and measured temperatures of one or more cooking zones, to the user. In an exemplary embodiment, the analog knobs may be motorized so that they correspond to the temperature of the cooking surface or the position of the motorized modulating valve. For example, when a user inputs a desired temperature on his or her smartphone, the analog knob disposed on the control panel may rotate to a position corresponding to the selected temperature. In another exemplary embodiment, when a user inputs a desired temperature on his or her smartphone, the analog knob disposed on the control panel may rotate to a position corresponding to the position of the motorized modulating valve; if the system opens the motorized modulating valve corresponding to a given analog knob to 50% of its capacity, the knob may be rotated 180 degrees to indicate to the user the position of the valve. In another exemplary embodiment, information related to the temperatures of individual cooking zones, the temperature of an exemplary resistance temperature detector disposed in the lid of the grill, or the positions of the motorized modulating valves may be communicated back to the user via a digital display disposed on a provided control panel, or on the user's smartphone. In another exemplary embodiment, one or a plurality of control knobs may be used to communicate electronic control signals comprising temperature commands from the user to the cooking system.

Each exemplary motorized modulating valve may be provided in fluid communication with one or more burners disposed in a portion of the cooking surface of the barbecue grill to create one or more “cooking zones.” Multiple motorized modulating valves may be provided in fluid communication with burners disposed beneath separate areas of the cooking surface to allow regions of the cooking surface to be heated to different temperatures. In a non-limiting example, a cooking apparatus may be provided with two motorized modulating valves, “ZA” and “ZB.” In this embodiment, motorized modulating valve ZA is provided in fluid communication with a burner disposed beneath the left half of the cooking surface, while modulating valve ZB is provided in fluid communication with a burner disposed beneath the right half of the cooking surface. Two temperature detecting devices in electronic communication with the electronic control module are provided and placed in position to measure the temperature of the two regions of the cooking surface associated with the burner in fluid communication with motorized modulating valves ZA and ZB, respectively. In this embodiment, the user may control the “cooking zone” associated with each motorized modulating valve independently. In this exemplary embodiment, the user may use his or her smartphone or the control panel to input a command to ignite the burner or burners associated with one or both cooking zones, and set the desired temperature for the left cooking zone to 300 degrees Fahrenheit, and the right cooking zone to 200 degrees Fahrenheit. In an alternative exemplary control configuration, ignition commands from the smartphone application may be restricted for safety reasons.

Additional cooking zones may optionally be added to this configuration through the addition of one or more modulating valves in fluid communication with one or more associated burners and a temperature measuring device disposed in a region of the cooking surface capable of measuring the temperature of the portion of the cooking surface associated with a given motorized modulating valve-burner pairing. In embodiments with multiple cooking zones, one or more heat-resistant panels may be used to define a partition between or among cooking zones, preventing heat from a hotter cooking zone from raising the temperature in a cooler one. In an exemplary configuration, a cooking system may be provided wherein a plurality of modulating valve-burner pairings comprise a single cooking zone.

A solenoid valve assembly may be provided to control the supply of fuel to one or more motorized modulating valves. The operation of a solenoid is well-known in the art. In an exemplary embodiment of the present disclosure, a solenoid may be provided as the first valve in the system in fluid communication with a fluid fuel source, which may have a regulator. In this non-limiting embodiment, the solenoid functions as a failsafe that may stop the flow of fluid fuel to the burners disposed in the barbecue grill under certain circumstances. Such circumstances may include a “shutoff” command from the user, or when the system does not detect a temperature increase or flame after supplying fuel to the burner or burners disposed in the system, in the event of a power loss, or if one or more temperature detection devices detects a dangerously high temperature. In this latter circumstance, the solenoid functions as a safety measure to prevent excess fluid fuel from venting.

One or more motorized modulating valves may be provided to provide variable flow of fuel to one or more burners in fluid communication with said motorized modulating valve. A motorized modulating valve in fluid communication with a fuel source and one or more burners may provide fluid fuel to be ignited at one or more burners at a rate corresponding to a temperature selected by a user or software being run by an electronic control module in electronic communication with each motorized modulating valve. The position of a motorized modulating valve may be adjusted by commands received from the electronic control module pursuant to a computer program stored on the electronic control module or by a user inputting commands through a control panel in electronic communication with the electronic control module or a remote device in wireless communication with an electronic control module.

A set point temperature may be attained at a cooking surface when the user commands the grill to ignite one or more burners and sets a desired temperature at one or more cooking zones. A computer program running on the electronic control module transmits (1) a command to the motorized modulating valve or valves corresponding to one or more selected cooking zones or burners to open, (2) a command to one or more ignitor modules disposed in a placement to ignite the selected cooking zones or burners, and (3) a command to the solenoid to open. An ignition command to one or more ignitor modules may be a command to pulse for a given timeframe. An exemplary ignition command may require multiple inputs by the user for safety purposes or may be a single input. Once the three indicated commands have been transmitted to the corresponding components within the system, the electronic control module may check the temperature at a temperature measuring device corresponding to the cooking zone and/or burner(s) selected by the user to ascertain whether the burner has successfully ignited. In one exemplary, non-limiting embodiment, once the electronic control module has confirmed ignition of the selected burner(s), it may command the selected motorized modulating valves to open further until the cooking surface associated with the burner(s) approach the user-selected temperature, at which point the electronic control module may transmit a command to the selected motorized modulating valve(s) to maintain or reduce the flow of fluid fuel to the burner(s) such that the desired cooking temperature is reached and maintained. The user may also close the lid of the barbeque grill and select a desired temperature for the air within the cooking cavity to reach. The electronic control module may transmit a command to the selected motorized modulating valve(s) to increase the flow of fluid fuel to the burner(s) in fluid communication with the motorized modulating valve. Once a temperature detection device disposed in the lid of the barbeque grill measures that the air is approaching the desired temperature, the electronic control module may transmit a command to the selected motorized modulating valve(s) to maintain or reduce the flow of fluid fuel to the burner(s) such that the desired cooking temperature in the space enclosed by the lid and the cooking surface is reached and maintained.

In an exemplary, non-limiting embodiment, all motorized modulating valves disposed in a cooking assembly may be set to a synchronous temperature setting to provide even heat distribution across the entire cooking surface and throughout the cooking volume. In this exemplary, non-limiting embodiment, a cooking system may be provided with a plurality of motorized modulating valves each in fluid communication with a respective burner or plurality of burners and each motorized modulating valve-burner(s) pairing set to maintain the same cooking temperature and the same valve position, and therefore the same flow rate of fuel. In this configuration, if a temperature detection module detects a temperature below the set temperature, then the control module sends a signal to the motorized modulating valves to increase gas flow, thereby raising the temperature of the cooking surface and volume. If a temperature detection module detects a temperature above the set temperature, the control module sends a signal to the modulating valves to decrease gas flow, thereby lowering the temperature of the cooking surface and volume. Such a configuration may include a thermocouple disposed near each burners and configured to detect a flame, and a resistance temperature detector disposed in the firebox to provide the detected temperature input to the control module. In this exemplary configuration, a plurality of motorized modulating valve-burner pairings are set to the same temperature and provide a larger cooking surface with superior consistent heat distribution.

In an exemplary, non-limiting embodiment, the control module may be configured to receive input commands to place one or a plurality of motorized modulating valves in a static position without automatic adjustment of fuel flow rate. For example, in this configuration, the user may input a command for one or a plurality of valves to open to a set percentage of maximum fuel flow rate such that the cooking system functions like a traditional gas grill with mechanical, manually-controlled valves. In this manner, the flow of fuel, and therefore the intensity of the cooking flame, will remain constant, including in circumstances such as when a grill lid is opened. When the grill lid is opened, heat escapes the cooking volume and a cooking system set for automatic temperature adjustment would then react to the sudden detected temperature decrease by increasing fuel flow. By setting the valves to a static position, the user may avoid an unwanted increase in flame intensity. A static setting would also allow the user to cook with a grill lid maintained in an open position while avoiding an increase in flame intensity, if no such increase is desired. An exemplary embodiment may also allow users to program their own static valve position settings. For example, the user may set a “Low” setting to correspond to a motorized modulating valve position that allows 5% of the maximum fuel flow rate to flow to one or a plurality of burners, a “Medium” setting to correspond to a motorized modulating valve position that allows 50% of the maximum fuel flow rate to flow to one or a plurality of burners, and a “High” setting to correspond to a motorized modulating valve position that allows the maximum fuel flow rate to flow to one or a plurality of burners.

A device capable of detecting and transmitting ambient temperature information, such as a resistance temperature detector, may be provided in electronic communication with an electronic control module and disposed in the containment structure housing in a location, such as the interior of the grill lid or the firebox, where it is capable of detecting the air temperature of the cooking volume. In this exemplary configuration, the electronic control module may detect the temperature of the cooking volume, which may be communicated to the user through a control panel or software application installed on a remote device, thereby allowing the electronic control module and user to monitor the temperature of the cooking volume and issue commands based upon such information. A resistance temperature detector is resistant to heat exposure and may operate under temperatures used in cooking associated with a barbeque grill. Resistance temperature detectors are well-known in the art.

A device capable of detecting and transmitting ambient temperature information, such as a thermocouple or resistance temperature detector, may be provided in electronic communication with an electronic control module and disposed in a cooking containment structure housing, such as near the cooking surface, where it is capable of detecting temperature of the cooking surface. In an exemplary embodiment, a plurality of resistance temperature detectors may be disposed in different locations near the cooking surface to detect the temperature of multiple regions of a cooking surface, each placed in proximity with one or more burners provided in fluid communication with one or a plurality of provided motorized modulating valves, with each region of the cooking surface defining a cooking zone. In this exemplary configuration, the electronic control module may detect the temperature of the cooking surface at a plurality of areas on the cooking surface, each defining a cooking zone, which may be communicated to the user through a control panel or software application installed on a remote device, thereby allowing the electronic control module and user to monitor the temperature of multiple cooking zones and issue commands to the motorized modulating valve or valves associated with a given cooking zone. The placement of the temperature detecting devices in this configuration is not intended to be limiting, as temperature detecting devices may be placed in numerous locations, such as in the region of the firebox below a given cooking zone, where each would be capable of detecting the temperature of a given cooking zone. Thermocouples and resistance temperature detectors are resistant to heat exposure and may operate under temperatures used in cooking associated with a barbeque grill. It is appreciated by those of skill in the art that a thermocouple may be used to detect a flame.

An exemplary electronic control module may implement a computer system capable of running executable programming comprising control logic as disclosed herein, which may be instructions supplied in the form of software or firmware. An electronic control module may include electronic memory capable of storing one or more executable instructions and one or more processors capable of executing the instructions stored on the electronic memory. Electronic forms of memory are well-known in the art and may include a number of formats, including random access memory (RAM), read-only memory (ROM), solid-state drives, flash memory cards, or a number of magnetic disk storage formats.

An exemplary multipoint control system may also contain one or more communications components capable of sending and receiving signals across one or more wired or wireless radio media, including, but not limited to, Bluetooth, Wi-Fi, and near-field communication (NFC). An electronic control module may also be capable of providing electricity to operate the valves, temperature measuring devices, and/or other components of the disclosed system. Power may be provided to the electronic control module by batteries, either rechargeable or single-use, or by a wired power supply capable of being plugged into a wall outlet.

An exemplary communications component may be capable of communicating with other computer processing devices, including, but not limited to, a smartphone, laptop, a dedicated remote, and/or Internet servers. Other computer processing devices may be capable of communicating with the communications component of the disclosed apparatus directly or through the Internet in an IoT (Internet of Things) application. A dedicated laptop computer or smartphone software application may be employed by the user to transmit commands to the disclosed apparatus, such as start-up, shut-off, temperature set points for the cooking surface or region thereof, and desired temperatures for the cooking space when the lid is closed.

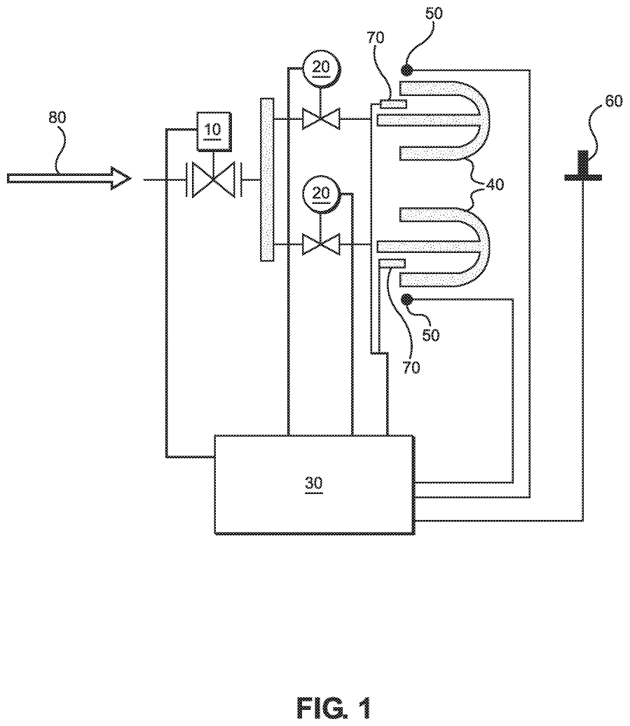

Referring now to the drawing wherein like numerals refer to like parts in the various views, FIG. 1 is an illustration of a component map of an exemplary configuration of the disclosed apparatus. A fluid fuel supply 80 provides fluid fuel to the disclosed apparatus and is in fluid communication with a solenoid valve 10. In this exemplary embodiment, a solenoid valve 10 is in fluid communication with two motorized modulating valves 20, each in fluid communication with a burner 40. A electronic control module 30 is provided in electronic communication with the solenoid 10, both motorized modulating valves, 20, two thermocouples 50 disposed near the area of the cooking surface associated with each burner, a resistance temperature detector 60 disposed in a location where it may detect the temperature of the air over the cooking surface, and two ignitor modules 70 disposed in proximity to the burners 40 such that they are capable of igniting a fluid fuel at the burners 40. An electronic connector 11 may communicate signals and receive signals from an electronic control module, and may receive a supply of electricity required to power and control the solenoid valve 10 and motorized modulating valves 20.

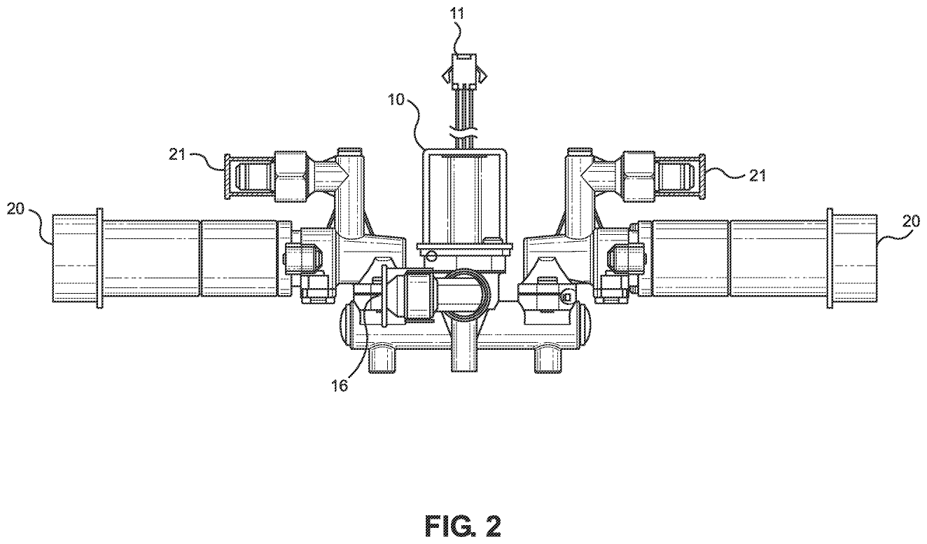

FIG. 2 is a side view of an exemplary configuration of a solenoid valve 10 provided in fluid communication with two motorized modulating valves 20. One or more gas outlets 21 may receive a conduit capable of delivering fluid fuel to one or more burners. A gas inlet 16 attached to a solenoid assembly 10 may receive a conduit capable of receiving fluid fuel from a fluid fuel source with or without a regulator.

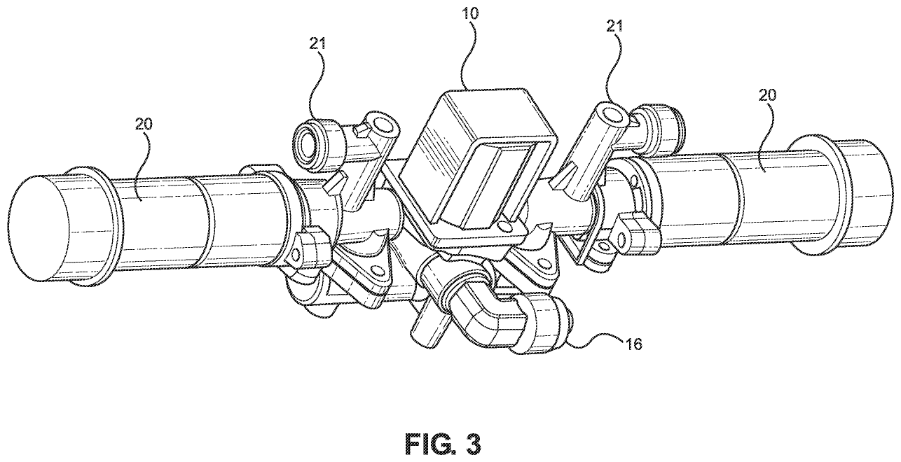

FIG. 3 is a perspective view of the exemplary configuration of a solenoid valve 10 provided in fluid communication with two motorized modulating valves 20. A gas outlet 21 may receive a conduit capable of delivering fluid fuel to one or more burners. A gas inlet 16 attached to and in fluid communication with a solenoid assembly 10 may receive a conduit capable of receiving fluid fuel from a fluid fuel source with or without a regulator.

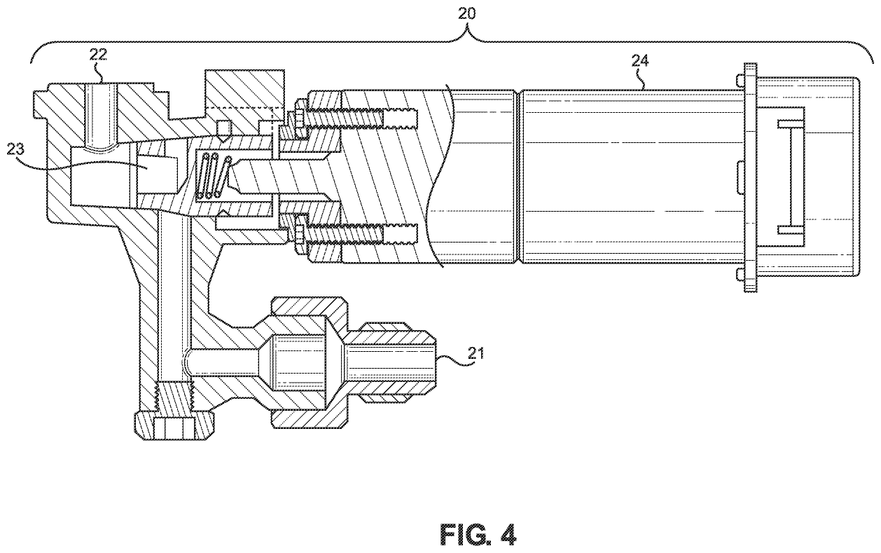

FIG. 4 is an internal view of an individual exemplary motorized modulating valve 20 of FIGS. 2 and 3. A gas outlet 21 may receive a conduit capable of delivering fluid fuel to one or more burners. A gas inlet 22 may receive a flow of fluid fuel from the solenoid assembly of FIGS. 2 and 3 via an attached conduit. An exemplary rotating adjustable valve plug 23 may be actuated by an electronically-controlled motor to control the rate of flow of fluid fuel to one or more burners. An electronically-controlled motor may be disposed within a housing 24 to actuate a rotating adjustable valve 23. The motorized modulating valve 20 may be powered by a connection directly to an electronic control module or to the solenoid valve assembly.

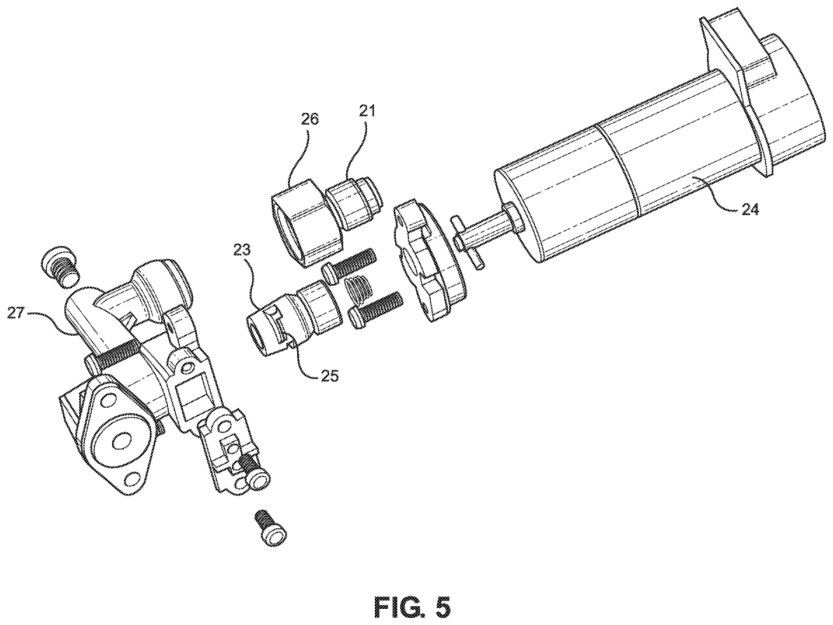

FIG. 5 is an exploded view of a motorized modulating valve 20 of FIGS. 2, 3, and 4. A gas outlet 21 may receive a conduit capable of delivering fluid fuel to one or more burners. A gas inlet 22 may receive a flow of fluid fuel from the solenoid assembly of FIGS. 2 and 3 via an attached conduit. An exemplary rotating adjustable valve 23 may be actuated by an electronically-controlled motor to control the rate of flow of fluid fuel to one or more burners. An electronically-controlled motor may be disposed within a housing 24 to actuate a rotating adjustable valve 23. The motorized modulating valve 20 may be powered by a connection directly to an electronic control module or to the solenoid valve assembly. A gas outlet 21 may be attached to a valve body 27 by an adaptor 26. An exemplary rotating adjustable valve plug 23 is shown as a cylinder terminating in a frustoconical protrusion. A channel 25 cut around a portion of the circumference of the frustoconical portion of the valve plug 23 progressively increases in volume as it progresses around the valve plug 23.

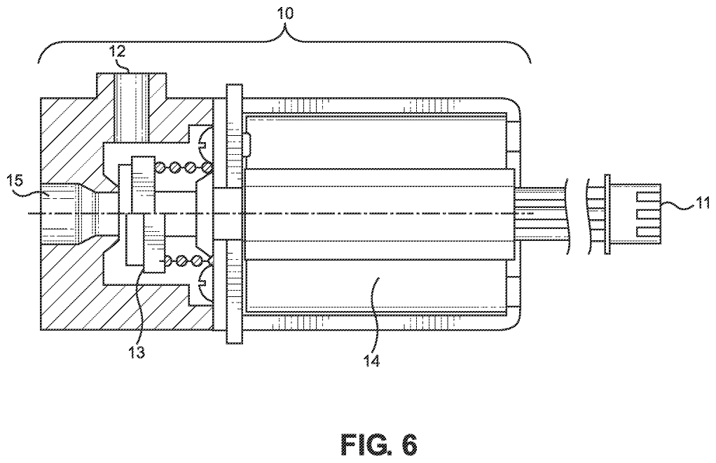

FIG. 6 is an internal view of an exemplary solenoid assembly 10 of FIGS. 2 and 3. An electronic connector 11 is provided to communicate signals to and from an electronic control module as well as power the magnetic valve actuator 14. A magnetic valve actuator 14 may open and close a valve 13 to allow a fluid fuel to flow through the solenoid assembly 10 or stop a fluid fuel from flowing through the solenoid assembly 10. A gas inlet 12 is provided to allow fluid fuel to enter the solenoid assembly and pass through the outlet 15 to one or more motorized modulating valves when the solenoid valve 13 is actuated to an open position.

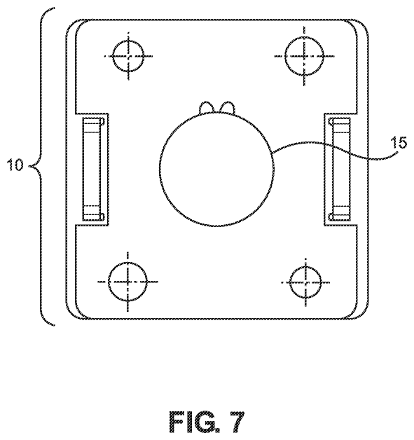

FIG. 7 is a lateral view of the exemplary solenoid valve of FIG. 6 showing the outlet 15 of the solenoid valve assembly 10.

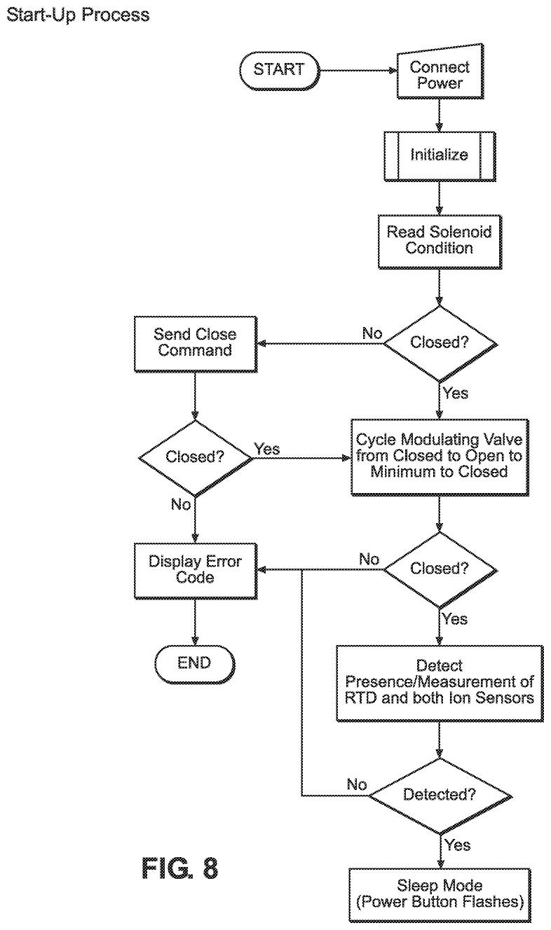

FIG. 8 illustrates a flow chart of a control method for checking the functionality of electronically controlled valves in an electronically-controlled cooking apparatus. In an exemplary embodiment of the present disclosure, this script is run by the computerized electronic control module to ensure the each of the valves in the present disclosure is operational. Such a series of commands functions both to ensure the cooking apparatus is safe to use and to alert the user if a malfunction has occurred.

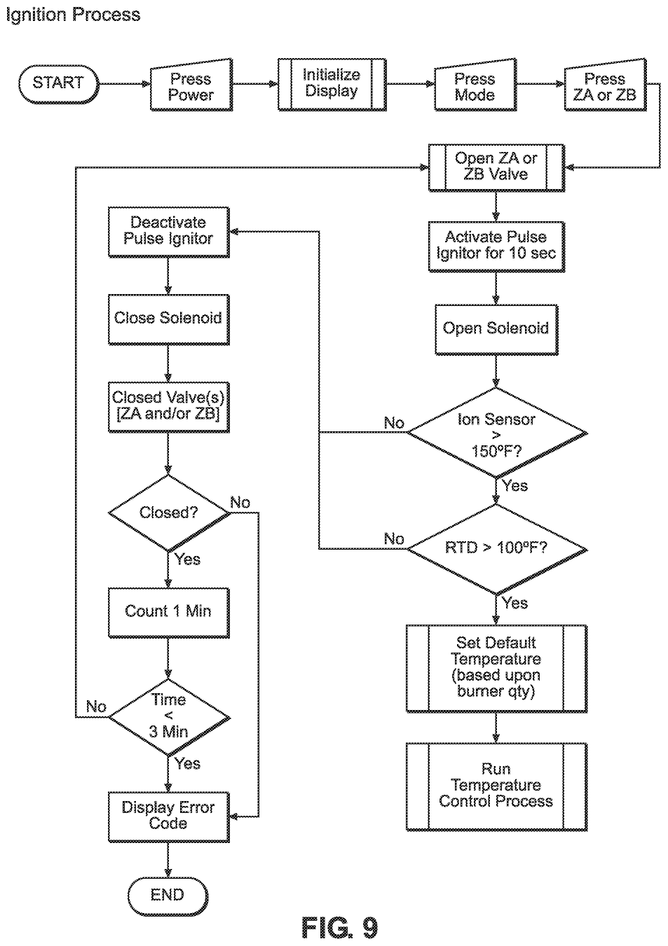

FIG. 9 illustrates a flow chart of a control method for igniting the burner of an electronically-controlled cooking apparatus.

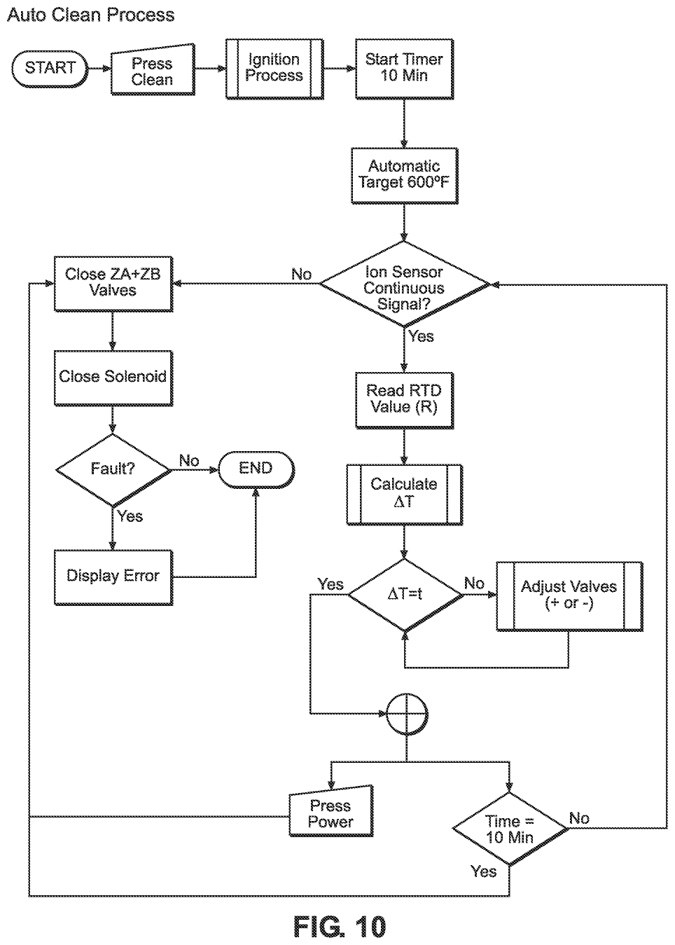

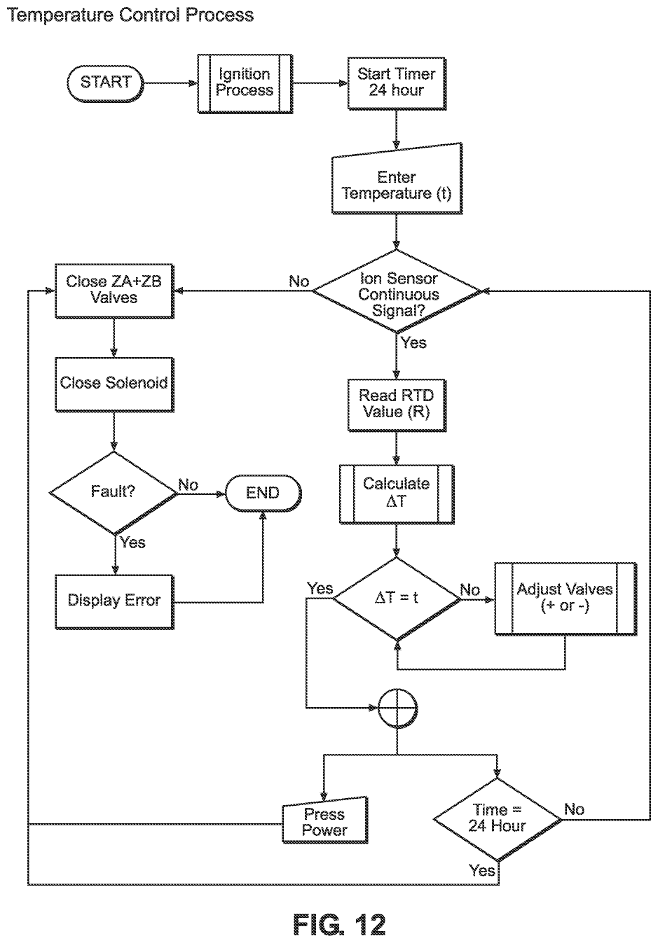

FIG. 10 illustrates an exemplary flow chart of a control method for utilizing the heating capacity of an electronically-controlled cooking apparatus to clean the burners and grate of a cooking apparatus. At and around 600 degrees Fahrenheit, hardened grease and other food by-product may be melted or burned. The cleaning capacity of heating a cooking appliance to such a temperature is well-known in the art. The flow chart illustrates control logic used by a computerized electronic control module to follow a pre-set control script to safely maintain a 600 degree Fahrenheit temperature for a period of 10 minutes. When the automatic cleaning function is activated, an internal 10 minute timer is set and initiated, and the temperature control process of FIG. 12 is run until the temperature of the grill reaches 600 degrees Fahrenheit. The fuel supply is shut off either when the 10 minute timer elapses or when the user elects to deactivate the cleaning mode.

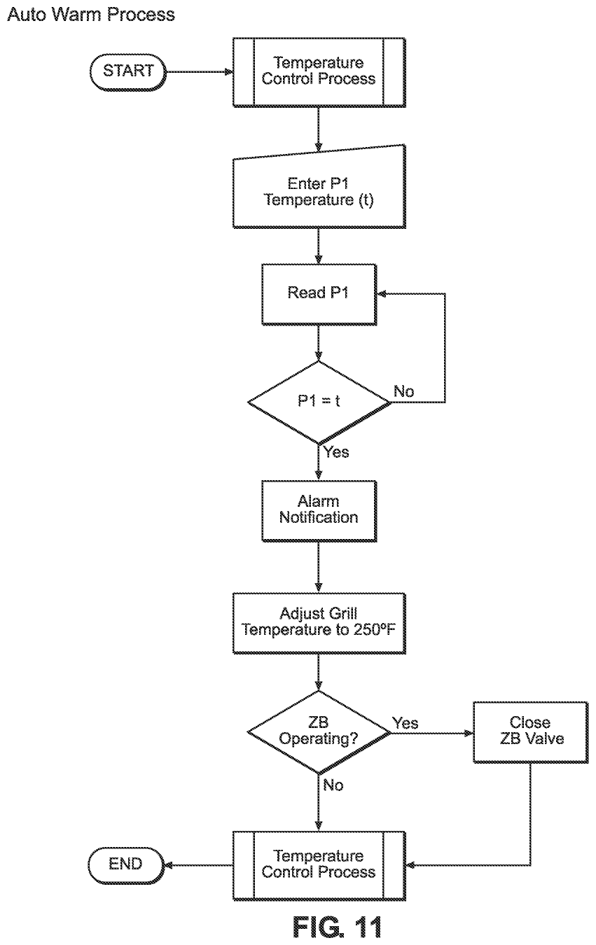

FIG. 11 illustrates a flow chart of a control method for automatically heating the cooking area of an electronically-controlled cooking apparatus in preparation for cooking. An automatic heating command may be employed by a user to conveniently raise the temperature of a cooking apparatus to a cooking temperature. Such a command may reduce the amount of time needed to cook a food article by allowing a cooking apparatus to be pre-heated at the press of a button. The computerized control script utilizes the temperature control process of FIG. 12 to raise the temperature to 250 degrees Fahrenheit, then closes one of the two motorized modulating valves to more efficiently maintain a 250 degree Fahrenheit temperature until the user begins to issue cooking commands to the system.

FIG. 12 illustrates a flow chart of a control method for achieving a desired temperature on an electronically-controlled cooking apparatus. The computerized control script runs the ignition sequence of FIG. 8 and initiates an internal 24-hour timer. The timer is a safety and efficiency feature that automatically shuts the valves of the grill if it has burned fuel for a period of 24 hours. The computerized electronic control module calculates ΔT, or the difference between the desired temperature set by the user and the actual temperature as measured by a temperature detection device (in this embodiment, that device is a resistance temperature detector). If the measured temperature is below the desired temperature, the electronic control module will adjust the selected motorized modulating valve to a position that allows a greater rate of flow of a fluid fuel from the fuel source to the burners. If the measured temperature is above the desired temperature, the electronic control module will adjust the selected motorized modulating valve to a position that allows a lesser rate of flow of a fluid fuel from the fuel source to the burners.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A cooking system comprising:
One or a plurality of solenoid valves provided in fluid communication with a supply of flammable gas;
One or a plurality of motorized modulating valves provided in fluid communication with each solenoid valve, wherein each motorized modulating valve comprises;
a plug valve that controls the amount of gas passing through the motorized modulating valve based on the degree of overlap of an opening disposed in a provided plug with a provided fixed orifice capable of defining an opening of variable size through which gas may pass; and
an electric motor configured to rotate the valve plug, wherein the size of said opening is adjusted by rotation of the valve plug;
One or a plurality of burners provided in fluid communication with each motorized modulating valve disposed in underlying relation to a cooking surface;
One or a plurality of ignitor modules configured to ignite gas at each burner;
One or a plurality of temperature detecting devices configured to measure cooking temperature;
A control panel through which a user may input commands for ignition and temperature; and
An electronic control module provided in electronic communication with the solenoid valve or valves, motorized modulating valve or valves, ignitor module or modules, temperature detecting device or devices, and control panel; wherein:
Said electronic control module is capable of receiving commands from the control panel, information from the temperature detecting device or devices and transmitting commands to the solenoid valve or valves, motorized modulating valve or valves, and ignitor module or modules;
The electronic control module further comprising control logic that adjusts the gas flow rate to one or a plurality of motorized modulating valves based on a temperature differential between a set temperature input by the user and the measured cooking temperature wherein:
a) If the set temperature is higher than the measured temperature, then the electronic control module increases the gas flow rate via one or a plurality of motorized modulating valves until the set temperature is reached.
b) If the set temperature is lower than the measured temperature, then the electronic control module decreases the gas flow rate via one or a plurality of motorized modulating valves until the set temperature is reached.
c) The electronic control module continuously monitors and adjusts the gas flow based on the temperature differential to maintain the desired set temperature.

2. The cooking system as recited in claim 1, wherein a temperature detecting device provided in electronic communication with the electronic control module is disposed in the firebox of a grill assembly in which the cooking system and cooking surface are disposed.

3. The cooking system as recited in claim 1, wherein the user may alternatively input commands for one or a plurality of motorized modulating valves to remain in a selected position.

4. The cooking system as recited in claim 1, wherein the user provides commands to the electronic control module via a remote electronic device.

5. The cooking system as recited in claim 1, wherein the control panel comprises one or plurality of motorized control knobs wherein:
Each motorized control knob is provided in electronic communication with the electronic control module and is configured to transmit a desired temperature setting;
A temperature scale is provided representing a range of temperature values, each indicating a specific temperature value; and
A motorized mechanism operatively connected to said control knob is configured to rotate the knob to a position on the temperature scale associated with the value selected by a user when a temperature input is received by any means other than the control knob.

6. The cooking system as recited in claim 1, wherein the control panel comprises a control knob wherein:
Said control knob is provided in electronic communication with the electronic control module and is configured to transmit a desired temperature setting; and
The user adjusts the set temperature of by turning the control knob.

7. The cooking system as recited in claim 1, wherein a temperature detecting device provided in electronic communication with the electronic control module is disposed in the cooking volume of a grill assembly in which the cooking system is disposed.

8. The cooking system as recited in claim 7, wherein a device configured to detect whether the lid of the grill assembly is open or closed is provided in electronic communication with an electronic control unit.

9. The cooking system as recited in claim 1, wherein a temperature detecting device provided in electronic communication with the electronic control module is disposed in the cooking volume of an oven assembly in which the cooking system is disposed.

10. The cooking system as recited in claim 1, wherein a temperature detecting device provided in electronic communication with the electronic control module is disposed in the cooking volume of a smoker assembly in which the cooking system is disposed.

11. The cooking system as recited in claim 1, wherein a plurality of thermocouples is provided in electronic communication with the electronic control module, with a thermocouple disposed in proximity to each burner and configured to detect the presence of a flame.

12. The cooking system as recited in claim 1, wherein the adjustable valve is selected from the group consisting essentially of ball valves, bonnet valves, butterfly valves, globe valves, and gate valves.

13. A cooking system comprising:
One or a plurality of solenoid valves provided in fluid communication with a supply of flammable gas;
A plurality of motorized modulating valves provided in fluid communication with each solenoid valve, wherein each motorized modulating valve comprises:
An adjustable valve that controls the amount of gas passing through the motorized modulating valve; and
an electric motor configured to adjust the position of the throttling mechanism within the adjustable valve, wherein the rate of gas flow is dependent upon the position of the throttling mechanism;
One or a plurality of burners provided in fluid communication with each motorized modulating valve disposed in underlying relation to a region of a cooking surface, defining a “cooking zone” associated with each motorized modulating valve;
One or a plurality of ignitor modules configured to ignite gas at each burner;
A plurality of temperature detecting devices configured to measure the temperature of each individual “cooking zone;”
A control panel through which a user may input commands for ignition and temperature to each “cooking zone,” extinguishment of the burner or burners corresponding to each “cooking zone,” and which displays the set temperature of each “cooking zone;” and
An electronic control module provided in electronic communication with the solenoid valve or valves, motorized modulating valves, ignitor modules, temperature detecting devices, and a control panel, wherein:
Said electronic control module is capable of receiving commands from the control panel, information from the temperature detecting devices and transmitting commands to the solenoid valve or valves, motorized modulating valve or valves, and ignitor module or modules;
The electronic control module further comprising control logic that adjusts the gas flow rate to each “cooking zone” based on a temperature differential between a set temperature input by the user through the control panel and the measured temperature of the corresponding “cooking zone,” wherein:
a) If the set temperature is higher than the measured temperature of the “cooking zone,” the electronic control module increases the gas flow via the motorized modulating valve associated with the corresponding “cooking zone” until the set temperature is reached.
b) If the set temperature of the “cooking zone” is lower than the measured temperature, then the electronic control module decreases the gas flow via the motorized modulating valve associated with the corresponding “cooking zone” until the set temperature is reached.
c) The electronic control module continuously monitors and adjusts the gas flow based on the temperature differential to maintain the desired set temperature in each “cooking zone.”

14. The cooking system as recited in claim 13, wherein the adjustable valve is selected from the group consisting essentially of ball valves, bonnet valves, butterfly valves, globe valves, and gate valves.

15. The cooking system as recited in claim 13, wherein panels defining a partition are disposed between each cooking zone.

16. The cooking system as recited in claim 13, wherein the user may input commands for one or a plurality of motorized modulating valves to remain in a selected position.

17. The cooking system as recited in claim 13, wherein the user provides commands to the electronic control module via a remote electronic device utilizing Bluetooth signals.

18. The cooking system as recited in claim 13, wherein the user provides commands to the electronic control module via a remote electronic device utilizing Wi-Fi signals.

19. The cooking system as recited in claim 13, wherein the control panel comprises a plurality of control knobs wherein:
Each control knob is provided in electronic communication with the electronic control module and is configured to transmit a desired temperature setting; and
The user adjusts the set temperature of each cooking zone by turning the control knob associated with that cooking zone.

20. A cooking system comprising:
A solenoid valve provided in fluid communication with a supply of flammable gas;
A plurality of motorized modulating valves provided in fluid communication with said solenoid valve, wherein each motorized modulating valve comprises:
An adjustable valve that controls the amount of gas passing through the motorized modulating valve; and
an electric motor configured to adjust the position of the throttling mechanism within the adjustable valve, wherein the rate of gas flow is dependent upon the position of the throttling mechanism;
One or a plurality of burners provided in fluid communication with each motorized modulating valve disposed in underlying relation to a region of a cooking surface, defining a “cooking zone” associated with each motorized modulating valve;
A plurality of ignitor modules configured to ignite gas at each burner;
A plurality of temperature detecting devices configured to measure the temperature of each “cooking zone;”
A control panel through which a user may input commands for ignition and temperature to each “cooking zone,” and extinguishment of the burner or burners corresponding to each “cooking zone;” and
An electronic control module provided in electronic communication with the solenoid valve or valves, motorized modulating valves, ignitor modules, temperature detecting devices, and a control panel, wherein:
Said electronic control module is capable of receiving commands from the control panel, information from the temperature detecting devices and transmitting commands to the solenoid valve or valves, motorized modulating valve or valves, and ignitor module or modules.
